(19) United States
(12) Patent Application Publication
(10) Pub. No.: US 2011/0162867 A1
(43) Pub. Date: Jul. 7, 2011

(54) TELEPHONE CABLE INSULATION COMPOSITION, AND TELEPHONE CABLE USING THEREOF

(75) Inventors: Jehun PARK, Daejeon (KR); Jae Kyu JANG, Daejeon (KR)

(73) Assignee: HANWHA CHEMICAL CORPORATION, Seoul (KR)

(21) Appl. No.: 12/683,846

(22) Filed: Jan. 7, 2010

(51) Int. Cl. H01B 3/30; C08K 5/3432

(52) U.S. Cl. 174/110 SR; 524/102

(57) ABSTRACT

Provided are an oxidation stabilizer for polyolefin, and an insulation composition comprising the same. The insulation composition according to the invention is to be used for coating and jacket of wires and cables, especially of telephone cables.

### BACKGROUND OF THE INVENTION

1. Field of the Invention

The present invention relates to an insulation composition, especially for coating telephone cables. Specifically, since oxidation stability is enhanced due to very low rate of migration into cable filler according to the present invention, the insulation composition according to the invention comprises an oxidation stabilizer that is stably usable for a long period.

2. Description of Related Art

Typical telephone cables consist of conductor, insulation and sheath. Conductors serving signal communication are insulated by polyolefin (usually HDPE), in which two strands are twisted in a pair. Again, the insulated conductor pairs are protected by metallic foil or polymeric jacket. The sheath serves to protect the conductor from external physical impact.

Cables of filled-type (filled with cable fillers) have been developed in order to minimize permeation of water, since the quality of communication of cables may be deteriorated when water is permeated. In case of not using cable fillers, water is diffused in the cable when water is permeated. Thus, in order to prevent such a phenomenon, for a filled type cable, the gap between the insulated core lines is filled with cable filler. When employing cable filler, however, the stabilizer such as anti-oxidant, which was added to polyolefin in the coating or jacket, may be rapidly migrated into the cable filler, to cause problem of lowered oxidation stability. In order to impart oxidation stability of cable coating, stabilizers such as metal deactivator and anti-oxidant are generally added to supplement the performance of polyolefin employed as the coating.

The reason why migration of the stabilizer into the cable filler causes problems is explained below. When a cable is connected in a pedestal outdoor in communication network, the sheath is taken off and the cable filler is wiped off, and thus the insulating coating is directly exposed to external environment such as temperature, air and moisture. In case of a filled type cable, however, the stabilizer in the insulating coating migrates into the cable filler, and thus oxidation rapidly progresses when the insulating coating is directly exposed to external environment. Resultantly, cracks or flakes may occur due to such oxidation, which deteriorate quality of communication.

Metal deactivator is used to reduce the phenomenon of mutual synergic promotion of oxidation that occurs upon contact of metal with polyolefin. It is used for polyolefin which contacts with metal conductors, as in wires or cables.

In general, metal deactivators and phenolic anti-oxidants are employed as anti-oxidant. Since most of phenolic anti-oxidants have high rate of extraction from polyolefin coating into cable filler, they can be hardly useful in certain uses requiring high oxidation stability.

### SUMMARY OF THE INVENTION

The object of the present invention is to provide an insulation composition having excellent oxidation stability. More specifically, the present invention intends to provide an insulation composition, which shows excellent oxidation stability, with low rate of migration of the oxidation stabilizer into the cable filler even after long-period use, to be stably usable for a long period, by adding a hindered amine as oxidation stabilizer, which has not been conventionally used as an oxidation stabilizer.

The present invention relates to an insulation composition, which comprises polyolefin resin and at least one hindered amine compound(s) selected from those represented by Chemical Formula (1) as oxidation stabilizer:

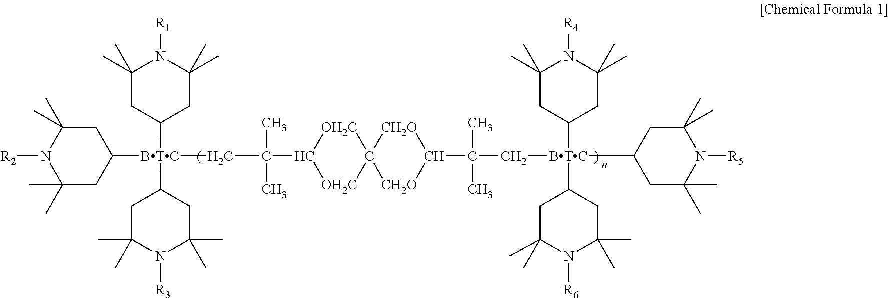

wherein, R₁ through R₆ independently represent H or CH₃, B.T.C represents

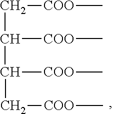

and n is an integer from 1 to 5.

The content of hindered amine compound represented by Chemical Formula (1) preferably is from 0.01 to 1.0 part by weight on the basis of 100 parts by weight of polyolefin resin.

The insulation composition according to the present invention may further comprise at least one hydrazine compound(s) selected from those represented by Chemical Formula (2):

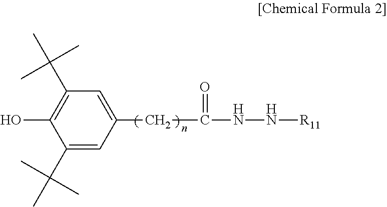

wherein, R₁₁ is selected from hydrogen, (C1˜C18)alkanoyl or

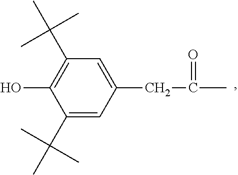

and n is an integer from 0 to 5.

Furthermore, the insulation composition according to the invention may further comprise phenolic anti-oxidant.

In addition, communication cables coated with the insulation composition according to the present invention are also within the scope of the present invention.

### DESCRIPTION OF SPECIFIC EMBODIMENTS

The advantages, features and aspects of the invention will become apparent from the following description of the embodiments with reference to the accompanying drawings, which is set forth hereinafter.

Now, the present invention is described in more detail.

The present inventors found that oxidation stability is very much enhanced when using the hindered amine of Chemical Formula (1); and also using anti-oxidant, especially hydrazine compound represented by Chemical Formula (2) along with the oxidation stabilizer; and completed the present invention.

According to a first embodiment of the present invention, provided is an insulation composition comprising polyolefin resin and at least one hindered amine(s) selected from those represented by Chemical Formula (1) as oxidation stabilizer:

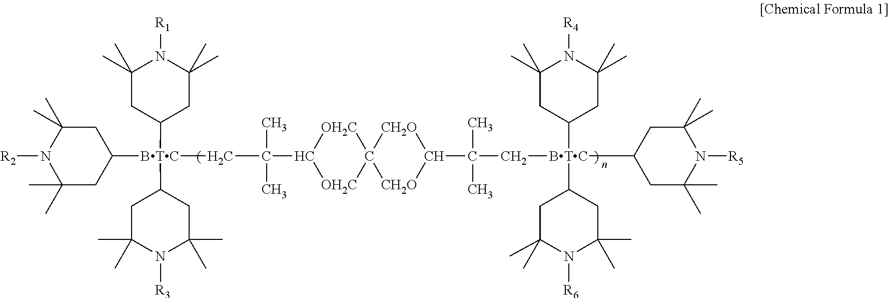

wherein, R₁ through R₆ independently represent H or CH₃, B.T.C represents

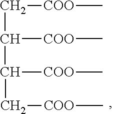

and n is an integer from 1 to 5.

As the hindered amine of Chemical Formula (1), used may be, for example, Adeka LA-63P or LA-68LD from Asahi denka.

The content may be preferably from 0.01 to 1.0 part by weight on the basis of 100 parts by weight of polyolefin resin. If the content is less than 0.01 part by weight, sufficient oxidation stability cannot be given to the insulation coating. When the content exceeds 1.0 part by weight, there is no more effect with increasing the amount of additive. More preferably, the content is within the range from 0.05 to 0.3 part by weight, because the oxidation stability would be much enhanced.

According to the second embodiment of the present invention, provided is an insulation composition comprising polyolefin resin, and at least one hindered amine(s) selected from those represented by Chemical Formula (1) as oxidation stabilizer, together with at least one hydrazine compound(s) selected from those represented by Chemical Formula (2):

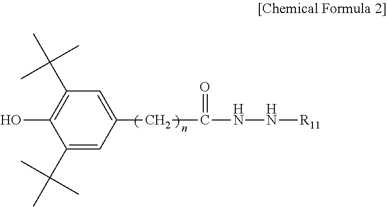

wherein, R₁₁ is selected from hydrogen, (C1˜C18)alkanoyl or

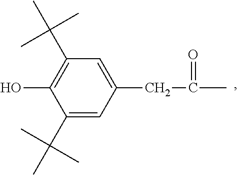

and n is an integer from 0 to 5.

As the hydrazine compound, used may be “IRGANOX 1024” from Ciba, 1,2-bis(3,5-di-tert-butyl-4-hydroxyhydrocinnamoyl)hydrazine, or the like.

The content of the hydrazine compound may be from 0.1 to 2.0 parts by weight on the basis of 100 parts by weight of polyolefin resin. The content is more preferably from 0.25 to 0.75 part by weight, since the synergic effect of using it along with the oxidation stabilizer would be highest then. If the content is less than 0.1 part by weight, sufficient oxidation stability cannot be given to the insulation coating. If the content exceeds 2.0 parts by weight, there would be no enhanced effect of oxidation stability with the increase of the amount of additive, but problems such as poor kneading of polyolefin resin with the additive, or migration of the additive to the surface of the coating may occur.

According to the third embodiment of the present invention, provided is an insulation composition comprising polyolefin resin, at least one hindered amine(s) selected from those represented by Chemical Formula (1) as oxidation stabilizer, at least one hydrazine compound(s) selected from those represented by Chemical Formula (2), and phenolic anti-oxidant. The content of hydrazine compound may be from 0.1 to 2.0 parts by weight, more preferably from 0.25 to 0.75 parts by weight on the basis of 100 parts by weight of polyolefin resin. The content of phenolic anti-oxidant preferably is from 0.01 to 0.3 part by weight on the basis of 100 parts by weight of polyolefin resin. If an excess amount is added, problems such as poor kneading of additives and migration of additives to the surface of the coating may occur.

The phenolic anti-oxidant preferably is a hindered phenolic anti-oxidant, specific examples of which include “YOSHINOX BHT”, “YOSHINOX BB”, “YOSHINOX 2246G”, “YOSHINOX 425”, “YOSHINOX 250”, “YOSHINOX 930”, “TOMINOX SS”, “TOMINOX TT”, “TOMINOX 917” and “TOMINOX 314” from API, “IRGANOX 1010”, “IRGANOX 1010FF”, “IRGANOX 1035”, “IRGANOX 1035FF”, “IRGANOX 1076”, “IRGANOX 1076FD”, “IRGANOX 1076DWJ”, “IRGANOX 1098”, “IRGANOX 135”, “IRGANOX 1330”, “IRGANOX 1425WL”, “IRGANOX 1520L”, “IRGANOX 1520SE”, “IRGANOX 1726”, “IRGANOX 245”, “IRGANOX 245FF”, “IRGANOX 245DWJ”, “IRGANOX 259”, “IRGANOX 3114”, “IRGANOX 3790”, “IRGANOX 5057”, “IRGANOX 565” and “IRGANOX 565DD” from Ciba, and “ADEKASTAB AO-20”, “ADEKASTAB AO-30”, “ADEKASTAB AO-40”, “ADEKASTAB AO-50”, “ADEKASTAB AO-50F”, “ADEKASTAB AO-60”, “ADEKASTAB AO-60G”, “ADEKASTAB AO-70”, “ADEKASTAB AO-80”, “ADEKASTAB AO-330”, “ADEKASTAB A-611”, “ADEKASTAB A-611RG”, “ADEKASTAB A-612”, “ADEKASTABA-612RG”, “ADEKASTABA-61311, “ADEKASTAB A-613RG”, “ADEKASTAB AO-51”, “ADEKASTAB AO-15”, “ADEKASTAB AO-18”, “ADEKASTAB AO-328” and “ADEKASTAB AO-37” from ADEKA. Among them, preferably usable is “IRGANOX 1010” from Ciba, tetrakis-{methylene-(3,5-di-tert-butyl-4-hydroxycinnamate)}methane.

Polyolefin resin according to the present invention may include polyethylene, polypropylene, and mixtures or blends thereof.

Furthermore, conventional additives may be added if required. Specific additives include, for example, UV absorbers, light stabilizers, metal deactivators, phosphites, hydroxyl amines, nitrones, benzofuranones, indolinones, stabilizers, fillers, reinforcing agents, plasticizers, lubricants, emulsifiers, pigments, dyes, optical brighteners, rheology additives, catalysts, flow-control agents, slip agents, crosslinking agents, anti-static agents, and blowing agents. The additive is preferably used in an amount from 0.01 to 2.0 parts by weight on the basis of 100 parts by weight of polyolefin resin, in order not to impede physical properties of other components.

The insulation composition according to the present invention can exhibit much enhanced oxidation stability due to the use of a compound having a certain chemical structure as oxidation stabilizer, as compared to the conventional composition simply comprising an anti-oxidant.

Thereby, problems of extraction of anti-oxidant into the cable filler can be overcome to reduce deterioration of oxidation stability. Accordingly the composition according to the invention is useful for insulating coating of telephone cables.

### BEST MODE

The present invention is further described by referring to specific Examples, not being intended to limit the scope of the invention by any means.

The components used in the Examples or Comparative Examples are as Follows
Polyethylene resin: density 0.945, melt index 0.6 g/10 min
Anti-oxidant 1: Irganox 1024 from Ciba, [1,2-bis(3,5-di-tert-butyl-4-hydroxyhydrocinnamoyl)hydrazine]
Anti-oxidant 2: Irganox 1010 from Ciba, [Tetrakis-{methylene-(3,5-di-tert-butyl-4-hydroxycinnamate)}methane]
Oxidation stabilizer: Adeka LA-63P from Asahi denka

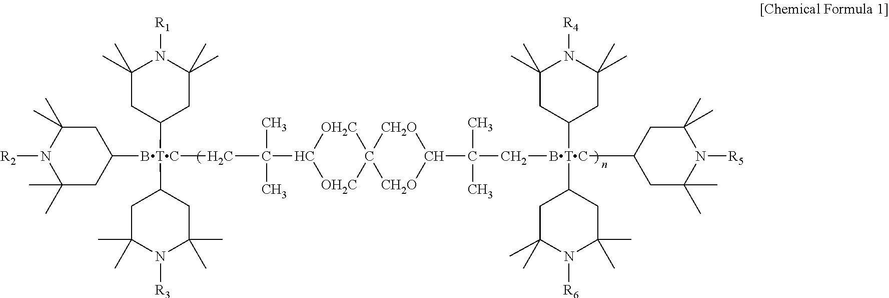

wherein, R₁ through R₆ independently represent CH₃, B.T.C represents

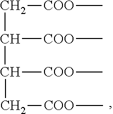

and n is 2.

### Examples 1-6

### Preparation of Insulation Compositions

A kneader and an extruder were used to mix polyethylene resin with oxidation stabilizer and anti-oxidant in the content listed in Table 1. The extrusion condition was melting temperature of 150° C., and revolution rate of screw at 45 RPM. Then, in order to copy a coating of small thickness, the composition was processed into a sheet having 250 μm of thickness at a temperature of 150° C. by using a molding press.

From the sheet thus prepared, samples are prepared as described below in order to trace in a laboratory the performance of the stabilizer upon applying it to a filled type cable.

In a 250 ml beaker, 800 g of cable filler of extended thermo plastic rubber (ETPR) type (tradename: EXK-443, from Penreco) was charged, and kept at 80° C. Then, the sheet that is 250 μm thick was cut into a size of 5×4 cm, and put into the cable filler of molten state to give sufficient immersion. The beaker containing the sample and cable filler was kept at 70° C. After standing for a certain period (1, 2, 3, 4 weeks), the sample was removed from the cable filler, and thoroughly wiped with paper towel, and the oxidation induction time was determined.

The oxidation induction time (OIT) is defined as duration from injection of oxygen at a certain temperature up to occurrence of exothermic decomposition of a sample, which is to determine oxidation stability of the sample. As the measuring instrument, a differential scanning calorimeter (model: 2920 from TA) was used under the condition of 200° C. in an aluminum pan. The physical properties measured are shown in Table 2.

### Comparative Examples 1˜3

Sheets were prepared according to the same procedure in Examples, but the experiments were carried out in a content shown in Table 1. The oxidation induction time thus determined was shown in Table 2.

TABLE 1

| | | Anti- | Anti- | Oxidation |
|---|---|---|---|---|
| | Polyethylene | oxidant 1 | oxidant 2 | stabilizer |
| | resin (parts | (part by | (part by | (part by |
| | by weight) | weight) | weight) | weight) |
| Ex. 1 | 100 | 0.55 | — | 0.25 |
| Ex. 2 | 100 | 0.55 | 0.15 | 0.05 |
| Ex. 3 | 100 | 0.55 | 0.15 | 0.10 |
| Ex. 4 | 100 | 0.55 | 0.15 | 0.15 |
| Ex. 5 | 100 | 0.55 | 0.15 | 0.20 |
| Ex. 6 | 100 | 0.55 | 0.15 | 0.25 |
| Comp. Ex. 1 | 100 | 0.35 | 0.25 | — |
| Comp. Ex. 2 | 100 | 0.55 | 0.25 | — |
| Comp. Ex. 3 | 100 | 0.55 | — | — |

TABLE 2

| | Oxidation induction time (min) | | | | |
|---|---|---|---|---|---|
| | 0 | 1 week | 2 weeks | 3 weeks | 4 weeks |
| Ex. 1 | 250 | 229 | 235 | 169 | 195 |
| Ex. 2 | 221 | 153 | 147 | 145 | 138 |
| Ex. 3 | 271 | 200 | 159 | 167 | 176 |
| Ex. 4 | 287 | 186 | 165 | 167 | 179 |
| Ex. 5 | 290 | 208 | 187 | 179 | 182 |
| Ex. 6 | 294 | 232 | 198 | 197 | 193 |
| Comp. Ex. 1 | 165 | 75 | 62 | 71 | 63 |
| Comp. Ex. 2 | 239 | 165 | 140 | 140 | 125 |
| Comp. Ex. 3 | 182 | 148 | 116 | 106 | 89 |

While the present invention has been described with respect to the specific embodiments, it will be apparent to those skilled in the art that various changes and modifications may be made without departing from the spirit and scope of the invention as defined in the following claims.

What is claimed is:

1. An insulation composition, which comprises polyolefin resin and at least one hindered amine compound(s) selected from those represented by Chemical Formula (1) as oxidation stabilizer: 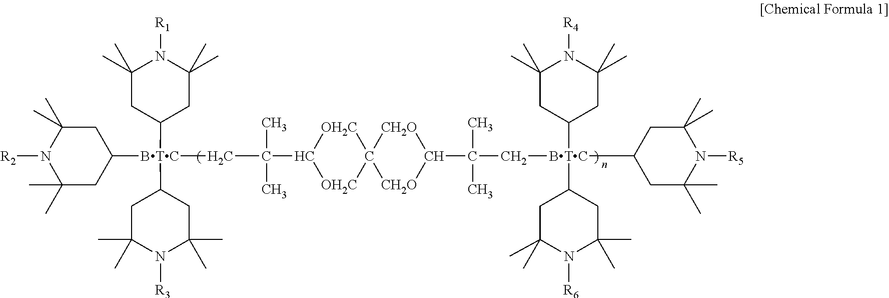
wherein, R₁ through R₆ independently represent H or CH₃, B.T.C represents 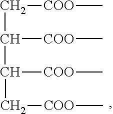
and n is an integer from 1 to 5.

2. The insulation composition according to claim 1, which further comprises at least one hydrazine compound(s) selected from those represented by Chemical Formula (2): 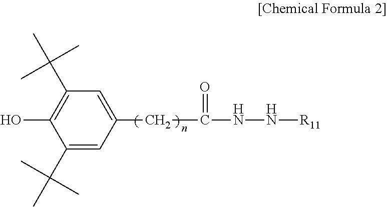
wherein, R₁₁ is selected from hydrogen, (C1˜18)alkanoyl or 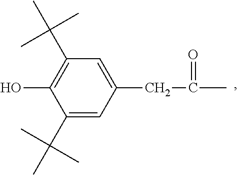
and n is an integer from 0 to 5.

3. The insulation composition according to claim 2, which further comprises phenolic anti-oxidant.

4. The insulation composition according to claim 1, wherein the content of the hindered amine compound of Chemical Formula (1) is from 0.01 to 1.0% by weight on the basis of 100 parts by weight of polyolefin resin.

5. The insulation composition according to claim 2, wherein the content of the hydrazine of Chemical Formula (2) is from 0.1 to 2.0% by weight on the basis of 100 parts by weight of polyolefin resin.

6. The insulation composition according to claim 3, wherein the content of the phenolic anti-oxidant is from 0.01 to 0.3 part by weight on the basis of 100 parts by weight of polyolefin resin.

7. The insulation composition according to claim 3, wherein the phenolic anti-oxidant is tetrakis-{methylene-(3,5-di-tert-butyl-4-hydroxycinnamate)}methane.

8. The insulation composition according to claim 1, wherein the polyolefin resin is polyethylene, polypropylene, a mixture, or a blend thereof.

9. A telephone cable coated with an insulation composition according to claim 1.

10. A telephone cable coated with an insulation composition according to claim 2.

11. A telephone cable coated with an insulation composition according to claim 3.
